(19) United States
(12) Patent Application Publication
(10) Pub. No.: US 2005/0145060 A1
(43) Pub. Date: Jul. 7, 2005

(54) Engine connecting rod for high performance applications and method of manufacture

(76) Inventor: Robert R. Weaver, Mooresville, NC (US)

Correspondence Address: DAVID M. CARTER;CARTER SCHNEDLER & MONTEITH, P.A., 56 CENTRAL AVENUE, SUITE 101, P.O. BOX 2985, ASHVILLE, NC, 28802, US

(21) Appl. No.: 11/064,588

(22) Filed: Feb. 23, 2005

Related U.S. Application Data
(63) Continuation-in-part of application No. 10/079,150, filed on Feb. 20, 2002, now abandoned.
(60) Provisional application No. 60/270,279, filed on Feb. 22, 2001.

(51) Int. Cl. B29C 49/00; G05G 1/00

(52) U.S. Cl. 74/593

(57) ABSTRACT

An internal combustion engine connecting rod, having an embodiment defining a hollow beam member and a process of manufacture are disclosed. The improvement substantially reduces beam tensile and compressive stress levels through application of elliptical and oval beam sections, conserving reciprocating and rotating connecting rod weight required in high performance engine applications.

### CROSS-REFERENCE TO RELATED PATENT APPLICATIONS

This is a continuation-in-part of pending U.S. patent application Ser. No. 10/079,150 filed Feb. 20, 2002, titled Engine Connecting Rod for High Performance Applications and Method of Manufacture. The benefit of U.S. Provisional Patent Application Ser. No. 60/270,279, filed Feb. 22, 2001, is claimed.

### BACKGROUND OF THE INVENTION

1. Field of the Invention

The present invention relates to the field of high performance internal combustion engines pertaining to a connecting rod having a Hollow Beam construction providing a lighter and stronger connecting rod beam member, accomplished by originated elliptical type and eccentric circular segmented walled cross-sections.

2. Description of Background Information

Hollow connecting rods have a history dating back to early automotive engines of the 1920's. Particularly, achieving notoriety in high performance engines. In the mid 1960's the Meyer and Drake, “Offy” racing engines were phased out of use at the Indianapolis 500 mile races after over 20 years of reliable winning performance using hollow connecting rods. Since then, numerous patents have been awarded for hollow connecting rod inventions based on improvements to the original and basic features of historically know hollow beam connecting rods. Beam features such as a round hollow tube or having elongated tubular cross-sections and inserts to close the hollow beam cavity remain as the bases utilized for patented improvements.

In the field of hollow connecting rods patents generally are for beam inventions applied to casting processes. Hollow connecting rods having cast cylindrical tubular beam members being disclosed in, for example, U.S. Pat. No. 5,140,869 to Mrdjenovich, et al (1992). This invention, a casting disclosure for an original and improved hollow beam casting is based on known hollow beam elements.

Another invention for hollow beam members based on known beam forms disclosed different method for making cross-sections and cavity closing inserts different from known types. Example, U.S. Pat. No. 3,482,467 to Volkel (1969), the beam member is described having inner wall with a full arc surface tangent to bores of the piston pin (first bore) and the crank-shaft journal connection (second bore). This requires that the hollow cavities be sealed with very long and questionably supported cavity seal insert to transfer high compressive and inertia loads. A potential for bearing distress results due to the long inserts being thin and deflecting under compressive and tensile loads closing bearing clearance that normally is about 0.002 inch. Volkel by claiming the inner wall tangent to wrist-pin bore and outer wall tangent to outer wrist-pin boss diameter, and claming wall thickness between inner and outer arcs to be made large as possible at lower end has a uniquely different invention. Two conditions make Volkel's connecting rod unsuitable for high performance use and different then the present invention. (1) Volkel created a massive lower thick wall, making the rod heavier with mass questionably distributed by the pronounced arc inner wall tangent to both bores. The long sealing insert essentially is without bearing support structure. (2) Very thin wall sections at the wrist-pin boss and sharp corners results in high stress concentration areas. Stress concentrations are areas were stress forces collect due to material shape and mass affecting load path. Generally stress concentrations generate higher stress level values and problem areas. Volkel's invention is an investment casting. In order to be manufactured compromises with strength, mass and configured form were made. Volkel's invention disclosed a very different way to make a hollow beam having an elongated cross-section and inserts based on his improvements to long recognized hollow connecting rod features.

Another invention improvement for making a hollow beam is also based on long recognized approaches, that being elongated cross-section, in direction of crank-shaft rotation. Disclosed is a method to make the hollow beam cross-section by using formed thin sheet metal to close the hollow beam and cap cavities. U.S. Pat. No. 5,370,093 to Hayes (1994) requires fabrication from sheet metal using multiple piece joined assembly. The thin sheet metal walls have limited load capacity and stress distribution, not considered appropriate for high performance applications. This is another invention disclosing different improvements to a hollow beam having an elongated cross-section based on known recognized hollow beam elements.

Reviewing the work of Volkel and Hayes and others, they do not provide comparable beam members of this invention. This invention improvement discloses means for lowering and smoothing stress levels and force flux flow distribution from wrist-pin boss to crank-shaft boss, achieving minimal cross-sectional beam area and mass, and methods to provide for design and manufacturing.

### SUMMARY OF THE INVENTION

In one form of this invention there is provided a connecting rod for an internal combustion engine including a hollow beam member. The rod includes a piston pin bearing boss and a crank shaft bearing boss. The first end of the hollow beam member is joined to the piston pin bearing boss through a smoothly blended curved region. The second end of the hollow beam member is joined to the crank shaft bearing boss through a second smoothly blended curved region. Each of the first and second curved regions has arcuate sides. The cross-sections of the first end and the second end form an ellipse. The walls of the ellipse are thicker in the long direction than in the short direction.

In accordance with another form of this invention there is provided a connecting rod for an internal combustion engine including a hollow beam member. The rod includes a piston pin bearing boss and a crank shaft bearing boss. The first end of the hollow beam member is joined to the piston pin bearing boss through a smoothly blended curved region. The second end of the hollow beam member is joined to the crank shaft bearing boss through a second smoothly blended curved region. Each of the first and second curved regions has arcuate sides. The cross-sections of the first end and the second end forming an oval. The walls of the oval are thicker in the long direction than in the short direction.

The present invention provides a connecting rod comprising a hollow beam member of near minimum cross-section area and mass achievable. It is preferred that this is accomplished by precise beam thin wall of variable blended thickness cross-sections having elliptical type or modified oval formation configured to smoothly distribute stress and eliminate stress concentration areas throughout the connecting rod. The elimination of stress concentrations lowers peak stress levels resulting in reliable performance at high engine RPM (Revolutions Per Minute) and improves fatigue life. Controlling and reducing stress levels and distribution patterns facilitates weight and mass reduction. This is important because weight reduction reduces inertia forces further lowering stress levels. Placement of beam defining cross-sections and section profile are defined with method to facilitate design and analysis of hollow beam connecting rod manufactured from high strength materials.

The primary objective of providing lower stress levels and lower reciprocating weight is to reduce inertia forces. Inertia forces affect engine performance and increase stress in connecting rods. Hollow rod beam weight reductions of 45 to 60 grams over competing solid beam connecting rods have occurred in designs. Reduction of 45 grams of reciprocating weight will reduce peak inertia force by about 400 pounds at peak RPM, determined in studies. Performance is improved by increasing compressive force by 400 pounds on the piston during the power stroke. This is possible because inertia force (400 lbs.) must be overcome during the early part of combustion by combustion pressure to push the piston during the power stroke.

Another objective is to provide a smooth aerodynamic shape to reduce effects of rod contact with the ambient oil particle environment and air occurring within an engine at high RPM.

An improvement shown in one embodiment of this invention is a new connecting rod beam cross-section geometry being closely related to the ellipse form. This objective being accomplished by varying cross-section profile shape and directional dimensions to meet requirements of stress analysis. The process provides cross-section geometry forms, being elliptical profile and other related geometric variations to form profiles having wall thickness or mass placed to form precise constant smoothly transitioning wall thickness to shape and blend stress patterns and flux flow within the beam member.

An improvement of one embodiment of this invention is having a procedural embodiment to locate profile cross-section forms on the beam longitudinal axis to define the connecting rod beam surface. A further purpose is to reduce the number of elements required to define a connecting rod beam to a few cross-section profiles, generally two profiles placed on the beam longitudinal axis. The beam form defining and design may be accomplished using computer programs. This objective simplifies and facilitates accurate and analyzed connecting rod design. Computer programs which may be used are Computer Aided Design (CAD), Finite Element Analysis (FEA) and Computer Numerical Controlled (CNC) machining. Another advantage of this improvement is design files may be computer generated and transferred by electronic means directly to CNC manufacturing machines and facilities.

An advantage of this invention is the embodiments are applicable for casting manufacturing processes for conventional connecting rods using the teachings of the present invention. Beam member wall thickness and dimensions being adjusted for material strength being the change.

An improvement shown in one embodiment of this invention is having a reliable connecting rod oil transfer tube from the crankshaft region to the piston pin bore. Beam movement and deflections would stress a rigidly fixed oil transfer tube installation. The oil tube shown provides a transfer tube that is compliant to bending, flexing, and to the tensile or compressive dynamic engine forces. The oil tube compliance is accomplished by an improved beam cavity sealing insert that provides a recess accommodating O-Ring seals. The tube is sealed from leakage and remains compliant to movement forces at the O-ring connection. The upper end, being secured fixed to the wrist-pin boss.

An improvement of one embodiment of this invention is a new application to provide a connecting rod bearing cap alignment embodiment to provide a more rigid alignment connection. This may be accomplished by machined sleeves circular extending above the connecting rod cap surface and extending around the cap connection bolts. The sleeves closely register into mating bored recesses in the rod journal connection providing an accurate close fitting cap to rod assembly. Previous sleeves in common use being separate elements pressed into the bearing cap, resulting in the cap being bored for sleeve installation weakening the structure and being compliant not a rigid connection.

Other objectives and advantages of the present invention will become apparent from the following descriptions, taken in connection with the accompanying drawings, wherein, by way of illustration and example, an embodiment of the present invention is disclosed.

### BRIEF DESCRIPTION OF THE DRAWINGS

The drawings constitute a part of this specification and include the embodiment of this invention.

FIG. 1 is a front elevation view of a connecting rod assembly illustrating one embodiment of the connecting rod of the present invention.

FIG. 2 is a side elevation view of the connecting rod of one embodiment of the present invention.

FIG. 3 is a longitudinal section view of the connecting rod of one embodiment of the present invention taken along the cut line 3-3 of FIG. 2.

FIG. 4 is a transverse sectional view of the connecting rod of one embodiment of the present invention taken along the cut line 4-4 of FIG. 1.

FIG. 5 is a transverse sectional view of the connecting rod of one embodiment of the present invention taken along the cut line 5-5 of FIG. 1.

FIG. 6 is a front elevation view of the connecting rod assembly of another embodiment of the present invention for purpose of illustrating transverse sections having ovate plane form.

FIG. 7 is a transverse section view of the connecting rod of FIG. 6 taken along the cut line 7-7 of FIG. 6.

FIG. 8 is a transverse section view of the connecting rod of FIG. 6 taken along the cut line 8-8 of FIG. 6.

### DETAILED DESCRIPTION OF THE INVENTION

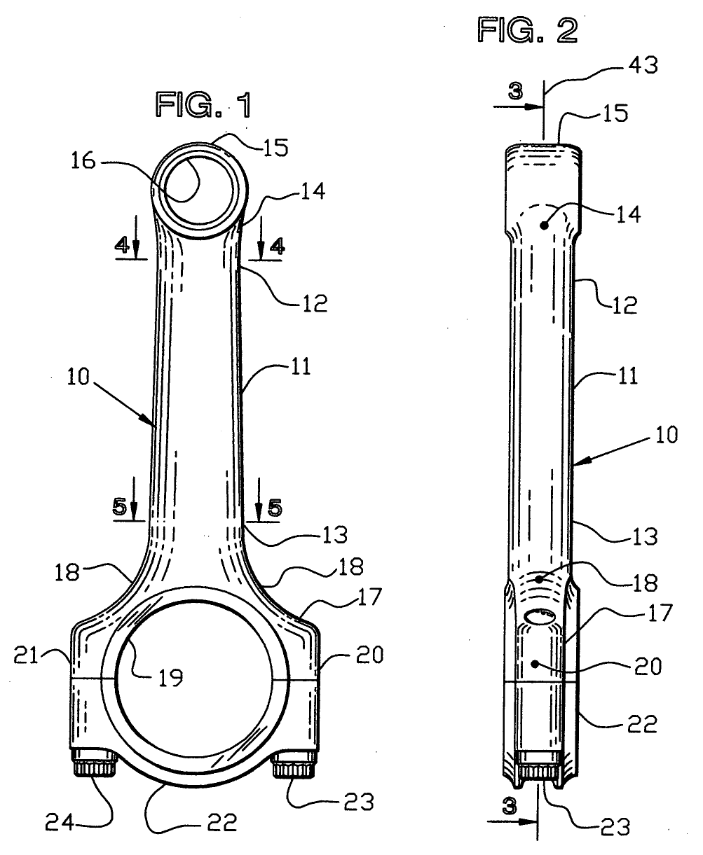

A general description being presented, with reference to FIG. 1 and FIG. 2 of the drawings there depicted a hollow connecting rod 10 for use in high performance engines. The connecting rod 10 comprising an elongate longitudinal beam member 11 having two opposite ends 12, 13 each forming a one-piece connection. Connection to first end 12 having blended arcuate sides 14, joining piston pin connecting boss member 15 having a round bearing surface 16, for cooperating with a piston pin (not shown). At beam member 11 opposite second end 13 is a crankshaft journal connecting member 17, having blended arcuate sides 18, including a round bearing surface 19 for cooperating with a bearing insert and crankshaft journal when secured thereto (not shown). Connecting member 17 having bolt boss 20, 21, secured thereto cap member 22 and bolts 23, 24. As noted in FIG. 1, beam cross-sections cut lines 4-4 and 5-5 define the beam member 11 by placement of profile cross-section placed at each cut line position. The beam member 11 form is then developed from the section profiles. Further details of features and continuity being disclosed continuing within the invention specification description.

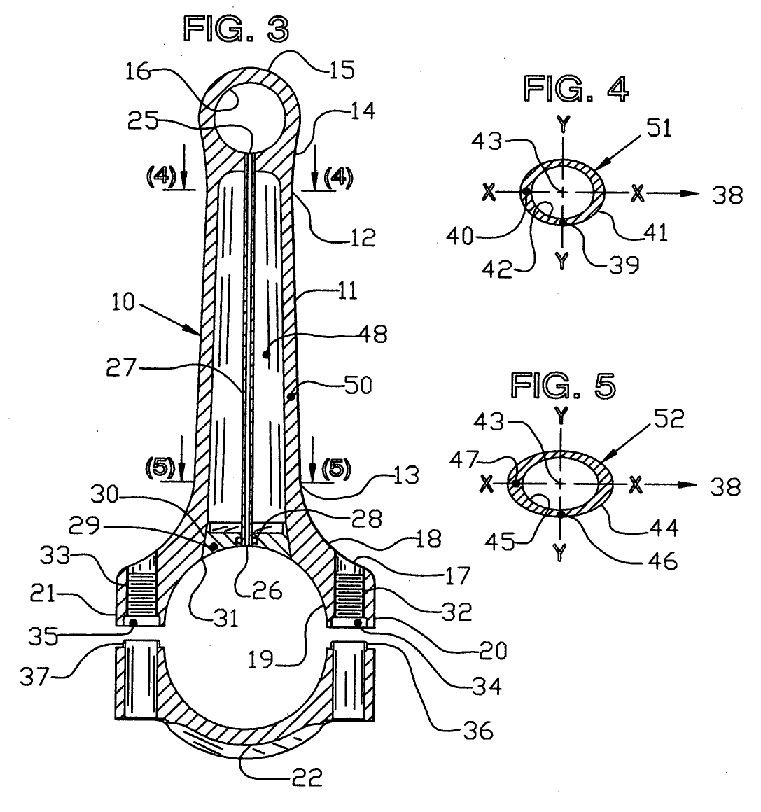

Beam member 11 Inner structure description being presented, with reference to FIG. 2, a longitudinal section view is taken along cut line 3-3 to disclose the inner structure of the connecting rod of this invention, best shown in FIG. 3 as follows. The piston pin connecting member 15 defines a first passage 25 which extends longitudinal axially 43 with respect to the beam member 11 to the round piston pin bearing surface 16. Viewing the opposite end, within the crank journal connecting member 17 is a second passage 26, extending to the round bearing surface 19. Continuing with FIG. 3 thereto passage 25 and 26 is secured oil passage tube 27 for the purpose of transferring oil from second passage 26 to first passage 25. Oil tube 27 being fixed and secured at first passage 25. Oil tube 27 being sealed at second passage 26 thereby a unique Oil-Ring 28 packing seals embodiment providing for axial motion differential between tube 27 and the connecting rod body region, thereto eliminate interacting movement and stress. Some applications do not require an oil passage tube therein oil tube passage 25 and 26 would be omitted, passage being closed.

Inner beam elements at crank-shaft connection being presented, Continuing in FIG. 3, the elongate beam member 11 there being hollow cavity 48 with thin wall 50 cross-section. Now continuing in FIG. 3, the cavity 48 of connecting rod member 11 there being an insert 29 embodiment fitted to beam wall section 30 for the purpose of sealing the cavity 48. The insert 29 having thin walls to limit compressive pressure force is bonded or fusion welded 31. With reference to FIG. 1, the bolts 23, 24 extend through bolt boss 20 and 21 from bearing cap 22 into threaded bores. Returning to FIG. 3, threaded bores 32 and 33 are illustrated. The bolts 23, 24 have been omitted from FIG. 3 for clarity to disclose the embodiment whereby bearing cap 22 assembles and therein is aligned to crank journal connecting member 17 as follows. Alignment receptacle elements 34, 35 are circular machined into bolt boss 20, 21 concentric with bolt and thread axis having a depth to accept matching, and close fitting extended machined circular elements 36, 37 on the mating surface of the bearing cap 22.

Method for locating the cross-section axis embodiment being depicted, referring to FIG. 1 to note locations of cut-lines 4-4 and 5-5 therein indicating cross-section location, FIG. 4 the first cross-section 51 and FIG. 5 the second 52 cross-section. The beam member elliptical cross-section embodiment feature of this invention there being disclosed, beginning with defining axis shown in FIG. 4, identifies the first cross-section 51. Note axis X-X of first cross-section 51, the axis X-X is in the direction of crankshaft plane of rotation 38 and is the major (long) axis of cross-section 51. Axis Y-Y is in the direction normal to crankshaft rotation and is the minor (short) axis of cross-section 51. FIG. 5 identifies the second cross-section 52, note axis X-X is also defined as the major axis and axis Y-Y is also defined as the minor axis. Both cross-sections 51 and 52 are centered on longitudinal axis 43.

First cross-section 51 and second cross-section 52 profile formation being disclosed. Returning to FIG. 4 first cross-section 51, elliptical type outer profile 41 and inner profile 42 define the beam wall 11 and variable wall thickness at first cross-section 51. Wall location 39 having least thickness on the minor Y-Y axis and wall location 40 having the most thickness on major axis X-X. Note that wall thickness embodiment constantly increases, beginning from the minor axis Y-Y changing gradually and smoothly without any discontinuities to the major axis X-X, thus defining cross-section 51 and wall thickness at 39 and 40.

Continuing now with the second cross-section, referring to FIG. 5 location of second cross-section 52 elliptical type outer profile 44 and inner profile 45 define beam wall 11 and wall thickness at cross-section 52. As noted previously least wall thickness 46 being on the minor Y-Y axis and most wall thickness 47 on major axis X-X being longer and having the more wall thickness on the major axis profile. The longer major axes being required to accommodate higher stress and bending moments in the plane of crank-shaft rotation.

Continuing with disclosure of the elliptical type profile embodiment of this invention. The descriptive ellipse example disclosed herein being determined using the mathematical “Equation of the Ellipse”, as used in Analytical Geometry. Variations of the ellipse equation may be used to alter the radius of curvature and the cross-section elliptical profile to distribute mass to optimize the beam member stress levels and load efficiency. By example, FIG. 4 the length dimension of the minor axis Y-Y may be significantly reduced making the beam cross-section thinner in the Y-Y direction, or the ellipse profile redefined as a “flattened circle” as described in Mark's, Mechanical Engineering Handbook. Further stating the example, the curves at wall thickness 40 on the major axis X-X being made with radii adding mass and area having precise curvature to accomplish smooth stress pattern and increased strength about the cross-section profile at wall 40.

Formulas for ellipses may be found in mechanical engineering handbooks. Mechanical Engineers' Handbook by Lionel S. Marks in general use provides formulas to develop various elliptical constructions applicable to this invention. The preferred method for ellipse form cross-sections development is the use of Computer Aided Design, CAD programs, creating an ellipse having the “Equation of the Ellipse” is simplified using CAD programs. These programs require input of only the major axis and the minor axis length dimensions. The program command then constructs the ellipse using “Equation of the Ellipse” as illustrated in FIG. 4 and FIG. 5.

Continuing with disclosure of the cross-section profile embodiment of this invention. Disclosed are a “second means” of construction for beam member 11. As with the ellipse method previously described the objective here is having least mass and least areas of stress concentration and lowering of stress levels, all are embodiments of this invention. The disclosed ellipse cross-section profile is supplemented by a “second means” disclosed to generate cross-section profiles and depending on application, a preferred method. The disclosed method provides improved radial clearance for cutting tooling in certain beam cavity 48 manufacturing applications and provides increase mass at the major axis end being more oval profile of increased cross-sectional area at the major axis ends, to improve stress levels and load path and strength.

Continuing with FIG. 6 disclosing “second means” construction for beam member 11 having more oval cross-section. As used herein, the term “elliptical type” shall include an ellipse and an oval. Theoretically the beam wall thickness may be constant all around. However, high performance engines generally require more mass at the ends of the X-X major axis for strength. Beginning with FIG. 7, disclosure of first cross-section 49 profile is depicted, wall thickness 53 section being comparatively thinner with a preferably near constant thickness extending in the Y-Y major axis direction a determined length, then blending to form curvature ends and wall thickness 57, having increased mass and cross-section area at the X-X axis, being the objective.

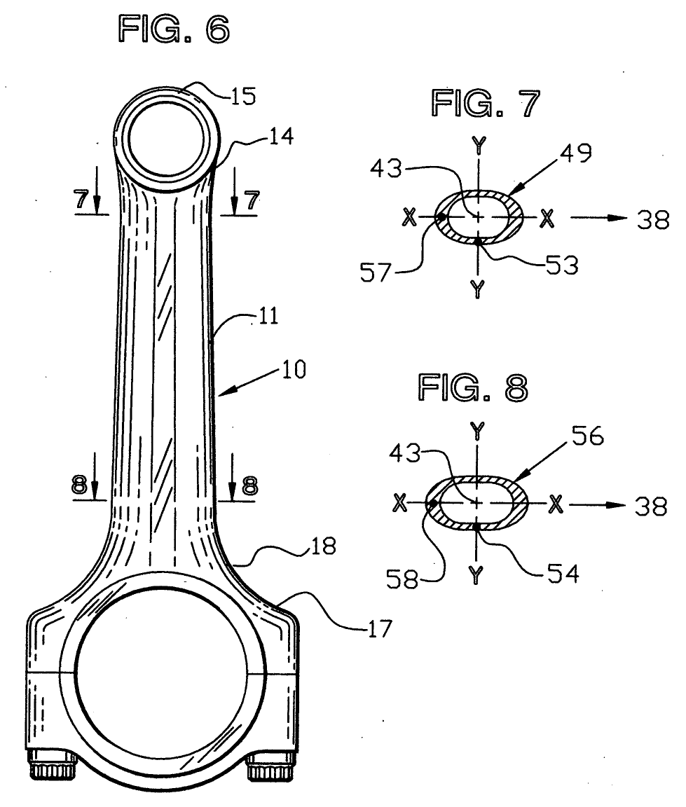

FIG. 8, continues disclosing “second means” disclosing the second cross-section 56 profile having wall thickness 54 being comparatively thinner with a preferably near constant thickness extending in the X-X major axis direction a determined length then blending increased wall thickness 58. The method used to determine first and second cross-section length dimension is best accomplished using FEA analysis to evaluate stress levels, patterns and stress concentrations, then making dimensional adjustment to define desired stress levels. The “second means” cross-section generating process is facilitated using preferred 3D CAD, particularly a “polyline command” feature that treats connected line segments and arc segments as a single object, thus smoothly varying a defined profile form.

Continuing with disclosure of longitudinal locating cross-sections on beam member 11, axis 43 being disclosed. Cut-lines in FIG. 1, FIG. 3 and FIG. 6 indicate location first and second cross-sections and transition planes were blending arcuate sides 14 from beam member 11 initiates into piston pin member 15 and transition plane were blending arcuate sides 18 from beam member 11 initiates into crank-shaft connecting member 17. The first and second cross-section location define the precise dimensional longitudinal location of first and second cross-sections. Initially locations being indicated from experience, studies and data, then being evaluated, using Finite Element Analysis, FEA, for final adjustment of longitudinal cross-section placement. This method utilizes features of Computer Aided Design, CAD, programs that “loft” or blend cross-sections of the present invention together with beam member 11 and the remaining elements to form a 3D solid defined computer model of the connecting rod 10. The generated computer “file” now defines the connecting rod 10 and cap member 22, being available to transmit to a machining center for manufacturing.

The present invention embodiments consider use of computer programs to facilitate design of connecting rods using Computer Aided Design, CAD, in particular, 3 Dimensional, or 3D CAD programs and Finite Element Analysis, FEA. Connecting Rod cross-sections such as ellipses, elliptical forms can be generated using capabilities of CAD programs to facilitate cross-section profile development to accomplish connecting rod design of the present invention. Computer 3D CAD programs feature a “Lofting command” that projects surface between two or more closed profiles, such as elliptical profiles to surface beam member 11 inner and the outer surfaces. Lofting also provides blending from surface transition planes at cross-section cut-lines from beam member 11 to piston pin member 15 and crankshaft connecting member 18. Thus forming together in continuity all the elements merge together in solid surface form, a 3D solid model, embodiment of the present invention. FEA may be used to analyze the 3D model for stress levels, stress distribution and for stress concentrations, deflections and dimensional change occurring by the analysis forces applied.

The connecting rod of the present invention configuration having profile form suitable of being manufactured by other methods, particularly investment casting, powder forging or conventional casting procedures. As best seen in FIG. 3 of this disclosure thereby illustrating that the connecting rod of this invention provides ideal casting form, having capable casting draft in the Y-Y minor axis direction and casting parting lines through the X-X major axis. The hollow cavity 48 being tapered, facilitating use of pattern removal and for placement of casting cores. Cavity sealing insert 29 therein installed in accordance with previous disclosure noted in FIG. 3. The connecting rod configuration herein being a smooth clean shape particularly suited for other processes. Further, the unique elliptical beam form of this invention provides means to improve strength of connecting rods and provide smoother stress distribution and limits stress concentration areas over known art. Particularly by increasing wall thickness to accommodate lower tensile strength materials being convenient using embodiments of the disclosed invention.

The hollow beam connecting rod being a “Closed Beam” hollow column is capable of higher load capacity over conventional “Open Beam” columns. Most conventional high performance connecting rods generally are H-Beam configuration, the “H” form open flanges being in direction of crankshaft rotation. Known as an “Open Beam” column, mass is centered on the longitudinal and neutral axis, requiring more mass to accommodate column and bending loads. The H-Beam open flange edges, being thin exposed edges, are affected with stress concentrations. The hollow “Closed Beam” concept is based on material mass being placed distance from the longitudinal and neutral axis, less material is required to accommodate column and bending loads. And, there are no free standing open edges. Reducing beam mass results in less reciprocating mass being accelerated by inertia forces at high engine speeds. High inertia force increases tensile loads on the beam member, a condition high performance engines are designed to limit. Calculating forces and loads affecting hollow connecting rods is essentially the same as for other connection rods. The difference, hollow connecting rods require additional beam analysis for elliptical type cross-sections, readily accomplished by the Engineering profession. Methods vary depending on engineering approach and effort. The method used regarding the present invention is a proprietary developed process.

The process used is designed to be simple, being based on experience and assembled study and analysis data. Entering applicable engine dimensions and data, RPM and component weights, the program determines the force loads acting on the connecting rod and beam as the crankshaft rotates through an engine cycle. Primary forces determined are (1) Tensile loads including peak tensile load. (2) Compressive loads including peak load. (3) Bending force and related angles.

Most important is the method applied to define the first and second cross-sections. Chosen for convenience and simplicity are engineering “Moments of Inertia” and “Cross-section Area” as the means to evaluate and determine elliptical cross-section profiles. Specifically “Moments of Inertia” are found for the X-X major axis and the Y-Y minor axis, then being compared to cross-section area. The objective being highest moments of inertia particularly in the X-X major axis and lowest cross-section area. Once cross-sections are developed on the computer the connecting rod is formed by computer “Lofting command” and 3D CAD design features using embodiments of the invention.

Finite analyses, FEA procedures using the determined load forces are applied to reveal stress levels and areas having high stress concentrations. Additional data is determined such as deflections and dimensional change occurring for the analysis forces applied. Using this data final design details are made to complete a hollow connecting rod.

1. An engine connecting rod having elliptical formed hollow beam member joined to a piston pin bearing boss at one end and joined to a parallel crankshaft bearing boss at opposite end joined thereto by arcuate surface flanks to piston pin bearing boss and to bolt bosses located each side of the crankshaft bearing boss there to connect with a connecting rod bearing cap member, comprising:
a beam member being hollow, having outer and inner surface being elliptical type form having cross-sections, dispersed longitudinally and centered on connecting rod longitudinal axis, major (long) axis being in direction of crankshaft plane of rotation and minor (short) axis being normal to crankshaft plane of rotation: said beam member having longitudinally positioned at least two elliptical type cross-section profiles to define said hollow beam member outer and inner surfaces, including an upper cross-section profile for joining into said piston pin bearing boss and a lower cross-section profile for joining into said crankshaft bearing boss;
said beam member outer surface being defined by longitudinal surface projection between said first and second outer cross-sectional profiles, internal surface, wall thickness and internal cavity surface therein defined by longitudinal surface projection between first and second inner cross-section profiles, first outer and inner profiles thereby being on a first cross-section plane, second outer and inner profiles thereby being on a second cross-section plane;
said outer and inner cross-section profiles cooperating to define precise varying beam member wall thickness having constant progressive profile thickness transition, blending wall thickness major axis to minor axis thereto form smoothly transitioning beam member wall thickness thereto shape and blend stress patterns and force flux flow within beam member;
said outer and inner cross-section profiles cooperating in the minor axis having least wall thickness and least cross-section length and cooperating in the major axis, having the most wall thickness and most cross-section length; said wall thickness being a smoothly blending profile from minor to major axis forming closed elliptical type profile cross-section;
an upper cross-section plane and a lower cross-section plane being positioned on said beam longitudinal axis whereby arcuate sides transition from hollow beam member upper cross-section profile, transition blending, joining into said piston pin bearing boss and said lower elliptical cross-section profile thereto transition blending, joining into said crankshaft bearing boss; and
said upper cross-section profile generally having least beam member cross-section area being sized to withstand maximum stress from combinations of axial, transverse and bending loads, and said lower elliptical cross-section profile generally having most beam member cross-section area and longer major axis to accommodate maximum stress, and bending loads.

2. The connecting rod of claim 1, wherein said hollow beam member cross-sections being oval profile thereto provide increased thickness and increased cross-sectional profile area at the major axis end, major axis end blending thereto near constant wall thickness at the minor axis, having less thickness and less minor axis length, wherein hollow beam varying wall thickness encloses cross-section profile.

3. The connecting rod of claim 1, wherein said hollow beam member cross-sections being profile providing constant wall thickness closed profile.

4. The connecting rod of claim 1, further including connecting rod bearing cap member including alignment sleeves machined onto the bearing cap surface, said alignment sleeves being raised machined circular elements on the mating surface of the bearing cap closely fitting into matching receiving alignment receptacles machined into the upper half of the connecting rod crankshaft journal body, alignment sleeves and through bolts being located on coincident axis, thereto secure assembly with bolt connections.

5. The connecting rod of claim 1, wherein said hollow beam member cavity opening at crankshaft connection is closed within having insert, said insert having thin wall sides at the innermost cavity connection, thin side wall depth determined for particular application to relieve compressive force pressure concentration; said insert adaptable to locating an oil transfer tube, said insert being bonded or fusion welded in place to the beam cavity opening; said insert outer surface being coincident with the surface of a crankpin bearing bore.

6. The connecting rod of claim 1, wherein said hollow connecting rod beam member is fitted with a tube member positioned on said connecting rod axis for the purpose of transferring oil from the crankshaft to the piston pin bearing surface, said tube member being fitted and secured to a receiving receptacle at the piston pin boss, the cavity sealing insert being fitted with an O-Ring packings to accept and seal the opposite end of the tube member at the crankshaft bearing end, thereby providing for axial motion differential between members.

7. The connecting rod of claim 1, wherein said hollow beam member cross member being elliptical.

8. A connecting rod for an internal combustion engine comprising:
a hollow beam member;
a piston pin bearing boss;
a crank shaft bearing boss;
the first end of said hollow beam member joined to said piston pin bearing boss through a first smoothly blended curved region; the second end of said hollow beam member joined to said crank shaft bearing boss through a second smoothly blended curved region; each of said first and second said curved regions having arcuate sides; the cross sections of said first and second ends of said hollow beam member forming an ellipse; the walls of said ellipse being thicker in the long direction than in the short direction.

9. A connecting rod for an internal combustion engine comprising:
a hollow beam member;
a piston pin bearing boss;
a crank shaft bearing boss;
the first end of said hollow beam member joined to said piston pin bearing boss through a first smoothly blended curved region; the second end of said hollow beam member joined to said crank shaft bearing boss through a second smoothly blended curved region; each of said first and second said curved regions having arcuate sides; the cross sections of said first and second ends of said hollow beam member forming an oval; the walls of said oval being thicker in the long direction than in the short direction.
